(19) United States
(12) Patent Application Publication
(10) Pub. No.: US 2006/0247326 A1
(43) Pub. Date: Nov. 2, 2006

(54) Adhesive composition with barrier characteristics

(76) Inventors: Guenter Henke, Neuss (DE); Markus Kruedenscheidt, Langenfeld (DE); Claudia Meckel-Jonas, Neuss (DE)

Correspondence Address: HENKEL CORPORATION, THE TRIAD, SUITE 200, 2200 RENAISSANCE BLVD., GULPH MILLS, PA, 19406, US

(21) Appl. No.: 11/377,487

(22) Filed: Mar. 16, 2006

Related U.S. Application Data
(63) Continuation of application No. PCT/EP04/10382, filed on Sep. 16, 2004.

(30) Foreign Application Priority Data
Sep. 25, 2003 (DE) 103 44 449.1

(51) Int. Cl. B29C 71/04

(52) U.S. Cl. 522/71

(57) ABSTRACT

An adhesive composition having barrier characteristics contains a) a compound having at least one NCO group and at least one reactive functional group that can be cured by irradiation and b) a nanoscale filler. Such compositions are useful as radiation curable one-component or two-component adhesives, particularly in the production of composite films with barrier characteristics. Composite films prepared in this manner can be utilized to package foods and medicaments.

### CROSS-REFERENCE TO RELATED APPLICATIONS

This application is a continuation under 35 USC Sections 365(c) and 120 of International Application No. PCT/EP2004/010382, filed 16 Sep. 2004 and published 14 Apr. 2005 as WO 2005/033242, which claims priority from German Application No. 10344449.1 filed 25 Sep. 2003, each of which is incorporated herein by reference in its entirety.

### FIELD OF THE INVENTION

This invention relates to an adhesive composition with barrier properties, to a process for the production of laminated films using the adhesive composition with barrier properties according to the invention and to the use of these laminated films for packaging.

### DISCUSSION OF THE RELATED ART

Many goods have to be protected from the ambient air or surrounding atmosphere for transportation or storage while other goods, particularly those with high water contents, have to be protected against drying out. Accordingly, they have to be packaged in a way which is suitable for completely excluding all or certain constituents of the surrounding atmosphere or for preventing the diffusion of water or flavors into the surrounding atmosphere and hence drying out of the packaged product or changes in its taste.

Whereas fuels and heating oils, for example, are transported and stored in suitable containers for this purpose, flexible packs are frequently used in the medical field (medicaments, ampoules) and in the staple and luxury food industry.

A particularly critical constituent of the ambient atmosphere is oxygen. With many packaged goods, such as foods or medicaments for example, the presence of oxygen can lead to oxidative deterioration or to the growth of germs which can also spoil the packaged product.

Polymer films of thermoplastic films are widely used for the production of flexible packs. These polymer films are normally produced by simple molding process, such as extrusion or blow molding.

Since the various requirements which a modern packaging film is expected to meet cannot all be satisfactorily fulfilled by a polymer film of a single polymer, a change was made some time ago to the production of so-called laminated films, i.e. films with a multilayer structure. In order to obtain the essential basic properties of a packaging film, such as tear strength, neutral taste and barrier properties, various processes are used to bond the individual film constituents together to form a laminated film.

For example, multilayer systems with separate barrier layers are produced by combining polyvinylidene chloride (PVDC), ethylene/vinyl alcohol (EVOH) and/or aluminium films/foils with polyethylene films, polyester films and/or polyvinyl chloride films. These multilayer systems can be made either by co-extrusion or by bonding separately produced films.

In another process, packaging films, for example based on polyethylene terephthalate or biaxially stretched polypropylene, are “metallized” (in vacuo) with an aluminium and/or silicon oxide layer.

Another known process uses the surface treatment of flexible packaging films by coating the films with solvent- or water-based polyvinylidene chloride solutions or dispersions.

PVDC- or EVOH-based coating compositions and adhesives often show poor adhesion to polyolefin films. Laminates of polyolefin films involving such adhesives can often be peeled apart by hand. Accordingly, a primer may have to be applied in a preliminary process step in order to ensure firm adhesion of the surface coating or the adhesive to the substrate film.

These known processes for the production of packaging/laminated materials with good barrier properties are generally very complicated and expensive. In practice, the use of metal layers by vapor deposition of metal or by lamination of metal foils results time and again in defects through a plurality of fine holes in the metal layer which seriously impair the otherwise good barrier effect of the metal layer.

In the search for more simple processes, there is a demand for adhesives that, besides the necessary adhesive effect, also act as a barrier against oxygen, flavors and water vapor.

EP 0906944 A2 relates to solventless polyurethane adhesives which have barrier properties against oxygen and moisture. These polyurethane adhesives are obtainable by reaction of a linear diol with a linear polyester to form a crystalline hydroxyl-terminated polyester which is reacted with a liquid diisocyanate in an NCO:OH ratio of ca. 1:1 to ca. 1.1:1. The polyurethane adhesives thus obtained are used as lamination adhesives. The disadvantage of coating compositions of this type is that they often lack the required flexibility. Another disadvantage is that long reaction times are necessary for obtaining good barrier properties.

WO 02/26908 describes lamination adhesive compositions based on polymeric binders and, more particularly, based on one- or two-component polyurethane adhesives which, in the binder matrix, contain fillers with a platelet-like crystallite structure having aspect ratios of >100. The lamination adhesives show a considerable reduction in the oxygen transmission rate. The fillers are dispersed, for example, into the hydroxyl-containing component of the two-component adhesive. The viscosity can be too high and/or the cure rate too slow for some applications.

### BRIEF SUMMARY OF THE INVENTION

The problem addressed by the present invention was to improve the processing and performance properties of adhesive compositions with barrier properties. Another problem addressed by the present invention was to provide adhesive compositions having barrier properties, more particularly against CO₂, O₂, N₂, water vapor and flavors, which could be applied at low temperatures, i.e. at ca. 30° C. to ca. 160° C. and preferably at ca. 40° C. to 120° C., and which would show good early adhesion. The adhesive compositions would be suitable in particular as lamination adhesives for the packaging of foods.

The present invention provides an adhesive composition with barrier properties containing

a) a compound containing at least one NCO group and at least one reactive functional group curable by radiation as component (A); and

b) a nanoscale filler as component (B).

In a particularly preferred embodiment, the adhesive composition according to the invention additionally contains

c) a compound containing at least two functional groups each with at least one acidic hydrogen atom as component (C);

and/or

d) an NCO-free compound containing at least one and preferably two or more reactive functional group(s) curable by radiation as component (D).

The use of an adhesive composition according to the invention with barrier properties against CO₂, O₂, N₂, water vapor and flavors as a lamination adhesive reduces the number of process steps involved in the production of laminated films with barrier properties because there is no longer any need for additional coatings with polyvinylidene chloride and/or ethylene/vinyl alcohol layers or for metallizing with aluminium layers to obtain those barrier properties. Through the absence of a metal layer, the laminated films comprise purely plastic films and hence are easier to dispose of. The laminated films according to the invention have an improved resistance to chemicals and an improved E-modulus in relation to comparable known films.

### DETAILED DESCRIPTION OF CERTAIN EMBODIMENTS OF THE INVENTION

The adhesive composition according to the invention has a viscosity at 70° C. of 100 mPa·s to 26,000 mPa·s (as measured with a Brookfield RVT DV-II digital viscosimeter, spindle 27) and, accordingly, may readily be applied at low temperatures, i.e., at temperatures of 40° C. to 120° C. In particular, it rapidly develops good early adhesion. Temperature-sensitive substrates, for example polyolefin films, can be securely bonded with the adhesive composition according to the invention without any damage to the substrate.

The adhesive composition according to the invention is radiation-curable and is used as a dual-cure system. Dual-cure systems are distinguished by the fact that they are both radiation-curable and can be cured by a second, independent curing mechanism.

The “hardening” or “curing” of a composition containing reactive functional groups is generally based on a polyreaction which is accompanied by an increase in the molecular weight of the compounds present in the composition. Normally, however, crosslinking reactions also take place at the same time.

The terms “hardening, “curing” or similar terms in the present specification relate to polyreactions which can take place within individual components of the particular composition considered in connection with the term. The polyreaction may be a radical, anionic or cationic polymerization, polycondensation or polyaddition reaction in which one reactive functional group is able to react with another, suitable functional group with an increase in the molecular weight of the molecule carrying that group. For example, this can be the radiation-induced polymerization of a component carrying double bonds. The terms also relate to polyreactions which can take place between various components of the particular composition in question, for example the polyaddition of a component carrying isocyanate groups with a component carrying OH groups. The terms also relate to polyreactions which can take place between a component of the composition under consideration and a component entering the composition through outside influences, for example the reaction between isocyanate groups and atmospheric moisture.

In the context of the present invention, the “radiation-curable” feature is understood to be the initiation of a polyreaction under the effect of radiation. The radiation can be any form of radiation which produces irreversible crosslinking in the crosslinkable adhesive layer to be irradiated. Suitable forms of radiation include in particular UV radiation, electron beams, visible light and IR radiation.

Molecular weights mentioned in relation to polymeric compounds represent the number average molecular weight (Mₙ), unless otherwise stated. All molecular weights mentioned are values obtainable by gel permeation chromatography (GPC), unless otherwise indicated.

Component (A) is obtainable by reaction of polyisocyanates with compounds containing both at least one NCO-reactive group and at least one radiation-curable, reactive functional group. Suitable polyisocyanates are aliphatic, aromatic and/or alicyclic isocyanates containing two or more, preferably two to at most about four, isocyanate groups. Monomeric polyisocyanates, more particularly monomeric diisocyanates, are particularly preferred for the purposes of the present invention. Examples of suitable monomeric polyisocyanates are 1,5-naphthylene diisocyanate, 2,2′-, 2,4- and/or 4,4′-diphenyl methane diisocyanate (MDI), hydrogenated MDI (H₁₂-MDI), allophanates of MDI, xylylene diisocyanate (XDI), tetramethyl xylylene diisocyanate (TMXDI), 4,4′-diphenyl dimethyl methane diisocyanate, di- and tetraalkyl diphenyl methane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanato-phenyl perfluoroethane, tetramethoxybutane-1,4-diisocyanate, 1,4-butane diisocyanate, 1,6-hexane diisocyanate (HDI), dicyclohexylmethane diisocyanate, cyclohexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate, 3,3-bis-chloromethylether-4,4′-diphenyl diisocyanate or sulfur-containing polyisocyanates. Other suitable diisocyanates are, for example, trimethyl hexamethylene diisocyanate, 1,4-diisocyanatobutane, 1,12-diisocyanatododecane and dimer fatty acid diisocyanate. Particularly suitable diisocyanates are tetramethylene, hexamethylene, undecane, dodecamethylene, 2,2,4-trimethylhexane, 2,3,3-trimethyl hexamethylene, 1,3-cyclohexane, 1,4-cyclohexane, 1,3- or 1,4-tetramethylxylene, isophorone, 4,4-dicyclohexylmethane and lysine ester diisocyanate.

In one particularly preferred embodiment of the invention, the polyisocyanate used is 1-isocyanatomethyl-3-isocyanato-1,5,5-trimethylcyclohexane (IPDI), tetramethyl xylylene diisocyanate (TMXDI), 2,2′-, 2,4- and/or 4,4′-diphenylmethane diisocyanate (MDI) or a mixture thereof. In the case of MDI, 4,4′-MDI and/or 2,4′-MDI with a purity of >97% is preferably used.

In a particular embodiment, mixtures of polyisocyanates are used, the mixture containing at least one uretdione, isocyanurate, allophanate, biuret, iminooxathiazine dione and/or oxadiazine trione polyisocyanate.

Allophanate polyisocyanates or polyisocyanate mixtures based on HDI, IPDI and/or 2,4′- or 4,4′-diisocyanatodicyclohexyl methane are particularly preferred. Polyisocyanates containing oxadiazine trione groups can be produced from diisocyanate and carbon dioxide.

Suitable at least trifunctional isocyanates are polyisocyanates obtained by trimerization or oligomerization of diisocyanates or by reaction of diisocyanates with polyfunctional compounds containing hydroxyl or amino groups. Isocyanates suitable for the production of trimers are the diisocyanates already mentioned above, trimerization products of the isocyanates HDI, MDI, TDI or IPDI being particularly preferred. Other suitable triisocyanates are adducts of diisocyanates and low molecular weight triols, more particularly the adducts of aromatic diisocyanates and triols such as, for example, trimethylolpropane or glycerol.

Also suitable for use are the polymeric isocyanates obtained, for example, as residue at the bottom of the distillation column in the distillation of diisocyanates. The polymeric MDI obtainable from the distillation residue in the distillation of MDI is particularly suitable.

In a preferred embodiment of the invention, the polyisocyanates used are monomeric polyisocyanates from the group consisting of 1,5-naphthylene diisocyanate, 2,2′-, 2,4- and/or 4,4′-diphenylmethane diisocyanate (MDI), the isomers of toluene diisocyanate (TDI), 1-isocyanatomethyl-3-isocyanato-1,5,5-trimethyl cyclohexane (IPDI), hexane-1,6-diisocyanate (HDI), tetramethyl xylylene diisocyanate (TMXDI), trimerization products of the isocyanates HDI, MDI, TDI or IPDI; and NCO-terminated polyurethane prepolymers based on HDI, MDI, TDI or IPDI and mixtures thereof.

In a particularly preferred embodiment of the invention, the polyisocyanates used are polyurethane prepolymers containing free NCO groups, more particularly so-called NCO-terminated polyurethane prepolymers. Polyurethane prepolymers containing free NCO groups are obtainable by reaction of polyols with monomeric polyisocyanates, the monomeric polyisocyanate being used in excess.

A polyol is understood to be a polyfunctional alcohol, i.e. a compound containing more than one OH group in the molecule. In addition, the polyol may contain other functional groups, for example sulfo groups. Various polyols may be used. Examples of such polyols are aliphatic polyols containing 2 to 4 OH groups per molecule. These OH groups may be both primary and secondary OH groups. Suitable aliphatic polyols include, for example, ethylene glycol, propane-1,2-diol, propane-1,3-diol, butane-1,4-diol, butane-1,3-diol, butane-2,3-diol, butene-1,4-diol, butine-1,4-diol, pentane-1,5-diol, and the isomeric pentanediols, pentenediols or pentinediols or mixtures of two or more thereof, hexane-1,6-diol and the isomeric hexanediols, hexenediols or hexinediols or mixtures of two or more thereof, heptane-1,7-diol and the isomeric heptane, heptene or heptinediols, octane-1,8-diol and the isomeric octane, octene or octinediols and higher homologs or isomers of the compounds mentioned, which are obtained in known manner from a step-by-step extension of the hydrocarbon chain by one CH₂ group at a time or by introducing branches into the carbon chain, or mixtures of two or more thereof.

Other suitable polyols are alcohols of relatively high functionality, such as for example glycerol, trimethylol propane, pentaerythritol, or sugar alcohols, such as sorbitol or glucose, and oligomeric ethers of the substances mentioned either as such or in the form of a mixture of two or more of the compounds mentioned with one another, for example polyglycerol with a degree of polymerization of about 2 to about 4.

Among the polyols, polyester polyols, polyether polyols, polyether polyols modified by vinyl polymers, polyester polyether polyols, polycaprolactone polyols or polytetramethylene polyols are particularly important. For example, polyester polyols are generally obtained by reaction of polyhydric alcohols with polybasic carboxylic acids.

Polyether polyols may also be used as the polyol. Polyether polyols are preferably obtained by reaction of low molecular weight polyols with alkylene oxides. The alkylene oxides preferably contain 2 to about 4 carbon atoms. Suitable polyether polyols are, for example, the reaction products of ethylene glycol, propylene glycol, the isomeric butanediols or hexanediols, as mentioned above, or mixtures of two or more thereof with ethylene oxide, propylene oxide or butylene oxide or mixtures of two or more thereof. Other suitable polyether polyols are products of the reaction of polyhydric alcohols, such as glycerol, trimethylol ethane or trimethylol propane, pentaerythritol or sugar alcohols or mixtures of two or more thereof, with the alkylene oxides mentioned to form polyether polyols.

Polyurethane prepolymers with free NCO groups based on polyester polyols or polyether polyols are preferred for the purposes of the invention. According to the invention, a polyether polyol and/or polyester polyol with a molecular weight of 200 to 10,000, preferably in the range from 200 to 6,000 g/mol and more particularly in the range from 200 to 4,000 g/mol or a mixture of polyether polyols or polyester polyols which meet the molecular weight requirement is particularly suitable for use as the polyol. Other references to the broad range of suitable polyol and isocyanate components, the chain extenders optionally used and processes for the production of polyurethane prepolymers can be found by the expert in the relevant scientific and patent literature on polyurethane prepolymers, cf. for example EP 150444, EP 0 590 398 A1 or WO 99/24486.

A “low-monomer” polyurethane prepolymer is preferably used for the production of the organic compound (A), “low-monomer” in the context of the present invention being understood to signify a low concentration of the monomeric duisocyanates in the PU prepolymer containing free NCO groups. The concentration of these so-called “residual monomers” is below 1, preferably between 0 and 0.5% by weight and more preferably between 0 and 0.1% by weight, based on the composition of the PU prepolymer containing free NCO groups. PU prepolymers containing free NCO groups and less than 0.1% by weight monomeric TDI are particularly preferred. Low-monomer PU prepolymers containing free NCO groups are known, for example, from DE 4136490, WO 01/40342 and WO 97/46603 and are expressly the subject of the present invention.

To obtain component (A), the polyisocyanates are reacted with compounds that contain both at least one NCO-reactive functional group and at least one radiation-curable reactive functional group. The NCO-reactive functional group is a group that has an active hydrogen atom attached to an N, O or S atom that can be determined by the Zerewitinoff test. Such hydrogen atoms include in particular the hydrogen atoms of water, carboxy, amino, imino, hydroxy and thiol groups. A radiation-curable reactive functional group is, for example, a group containing a carbon-carbon double bond. Suitable compounds are, for example, polyacrylates, polyesters, polyethers, polycarbonates, polyacetals, polyurethanes, polyolefins or rubber polymers, such as nitrile or styrene/butadiene rubber, providing they contain at least one reactive functional group curable by radiation, preferably in the form of UV light or electron beams, and at least one acidic hydrogen atom.

In the preferred embodiment, the compound used as component (A) contains at least one free NCO group and at least one (meth)acrylic group. Derivatives of acrylic acid, preferably acrylates and methacrylates, are preferably used for reaction with the polyisocyanate for the production of component (A). Suitable compounds are poly(meth)acrylates, polyester (meth)acrylates, epoxy (meth)acrylates or polyurethane (meth)acrylates. “(Meth)acrylate” is used in the following as an abbreviation for “acrylate and/or methacrylate”.

Component (A) is preferably a reaction product of at least one polyisocyanate with at least one (meth)acrylate corresponding to general formula (I):
H₂C═CR¹—C(═O)—O—R²—Y (I)
where
Y is an NCO-reactive group, preferably OH, COOH, SH, NH₂, NHR^{3′};
R¹ is H, CH₃;
R² is a saturated or unsaturated, linear or branched C₂₋₂₁, preferably C₂₋₆, alkylene group optionally substituted by functional groups, for example by a phenoxy or acetoxy group, more particularly an ethylene, propylene, isopropylene, n-butylene, isobutylene group or a C₂₋₄ alkylene oxide group, preferably an ethylene oxide and/or propylene oxide group and, more particularly, an ethylene oxide group containing 2 to 10 ethylene oxide units and/or a propylene oxide group containing 1 to 7 propylene oxide units;
R³ is a linear or branched, saturated or unsaturated C₁₋₁₈ alkyl group; C₅₋₈ cycloalkyl, C₅₋₈ cycloalkyl, C₆₋₁₀ aryl, C₇₋₁₂ aralkyl.

The production of (meth)acrylates corresponding to formula (I) is known to the expert.

Preferred (meth)acrylates (II) are hydroxy(meth)acrylates (Y═OH), for example 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 6-hydroxyhexyl acrylate, 6-hydroxyhexyl methacrylate, polyethylene glycol acrylate, polyethylene glycol methacrylate, polypropylene glycol acrylate and polypropylene glycol methacrylate, glycerol mono(meth)acrylate, 1,3-glycerol di(meth)acrylate, 3-phenoxy-2-hydroxypropyl (meth)acrylate, 3-toluyloxy-2-hydroxypropyl (meth)acrylate, 3-acetoxy-2-hydroxypropyl (meth)acrylate, 2-hydroxy-3-[(2-methyl-1-oxo-2-propenyl)-hydroxypropyl]-ester of 4-hydroxybenzoic acid, 2-hydroxybutyl (meth)acrylate, 3-hydroxybutyl (meth)acrylate, 4-hydroxybutyl (meth)acrylate, 6-hydroxyhexyl (meth)acrylate. The hydroxy acrylates or methacrylates are used individually or in admixture.

The quantities of polyisocyanate and (meth)acrylate corresponding to general formula (I) may be selected in a broad range. Thus, the ratio of NCO group of the polyisocyanate to NCO-reactive group Y of the (meth)acrylate corresponding to general formula (I) may be between 0.6:1 to 20:1. The NCO:Y ratio is preferably 1.2:1 to 10:1.

The molecular weight of component (A) is in the range from 100 g/mol to 10,000 g/mol, preferably in the range from 110 g/mol to 6,000 g/mol and more particularly in the range from 120 g/mol to 4,000 g/mol. The NCO content of component (A) is between 2% by weight and 30% by weight, preferably between 4% by weight and 25% by weight and more particularly between 6% by weight and 20% by weight (as determined by the method of Spiegelberger). The adhesive according to the invention contains 5 to 98% by weight, preferably 20 to 97.5% by weight and more particularly 40 to 95% by weight of component (A), based on the total quantity of the adhesive composition.

The adhesive composition according to the invention contains at least one nanoscale filler as component (B). Nanoscale fillers are also known as nanodisperse fillers or “nanoparticles” because the smallest particle forming a rigid unit in the dispersion in the number-weighted average of all particles has a dimension of no more than 1,000 nanometers (nm), preferably no more than 500 nm and, more particularly, no more than 100 nm in at least one direction selectable as required for each particle. For example, the nanoparticles have a spherical, rodlet-like or platelet-like structure or are mixtures of various structures. The nanoparticles present in the nanoscale filler preferably have sizes of 1 to 40 nm and more particularly 3 to 30 nm as a number-weighted average. The particle size is preferably determined by the UPA method (Ultrafine Particle Analyzer), for example by laser light back scattering. In order to prevent or avoid agglomeration or coalescence of the nanoparticles, the nanoparticles may be surface-modified or surface-coated in known manner. One process for the production of agglomerate-free nanoparticles is described in DE-A-19614136, columns 8 to 10, with reference to the example of iron oxide particles. Some possible methods for the surface-coating of such nanoparticles to avoid agglomeration are described in DE-A-19726282.

A preferred embodiment of the invention is characterized by the use of nanoscale fillers of which the smallest constituents forming a rigid unit in the dispersion each have a dimension in two directions perpendicular to one another, selectable as required, of at least ten times the size of the constituents in the direction with the smallest dimension of the constituent. The thickness of these particles is preferably smaller than 10 nm.

The nanoscale filler is selected from the group consisting of oxides, nitrides, halides, sulfides, carbides, tellurides, selenides of the 2^{nd} to 4^{th} main group, the transition elements or the lanthanides, more particularly oxides, hydroxides, nitrides, halides, carbides or mixed oxide/hydroxide/halite compounds of aluminium, silicon, zirconium, titanium, tin, zinc, iron or the alkali (alkaline earth) metals. These materials are essentially aluminas, for example aluminium oxides, boehmite, bayerite, gibbsite, diaspore and the like. Layer silicates such as, for example, bentonite, montmorillonite, hydrotalcite, hectorite, kaolinite, boehmite, mica, vermiculite or mixtures thereof are suitable. Phyllosilicates, such as magnesium silicate or aluminium silicate, and montmorillonite, saponite, beidellite, nontronite, hectorite, stevensite, vermiculite, halloysite or synthetic analogs thereof are particularly preferred. Of the cristobalite, quartz and tridynite modifications of silicon dioxide, the quartz modification is preferred. Other suitable nanoscale fillers are magnesium oxide, aluminium oxide, magnesium fluoride, cadmium sulfide, zinc sulfide, cadmium selenide and the like.

Through the build-up of labyrinth-like structures of the nanoscale fillers in the adhesive matrix, the diffusion path of low molecular weight compounds, such as for example oxygen, water, carbon dioxide, aromas and/or flavors, is lengthened to such an extent that their passage through the adhesive layer is drastically changed or, ideally, is even completely suppressed.

The adhesive according to the invention contains 2 to 30% by weight, preferably 2.5 to 20% by weight and more particularly 5 to 15% by weight of the nanoscale filler as component (B), based on the total quantity of the adhesive composition.

In a particularly preferred embodiment of the invention, the adhesive composition contains at least one compound containing at least two functional groups each with at least one acidic hydrogen atom as component (C) and/or at least one NCO-free compound containing at least one and preferably two or more radiation-curable reactive functional group(s) as component (D). In this embodiment, both component (C) and component (D) can perform a dual function. They may both act on the one hand as a preferred dispersion medium for the nanoscale filler and, on the other hand, as a hardener (=component (C)) or reactive diluent (=component (D)). The nanoscale filler is preferably present in component (C) and/or component (D). In a particularly preferred embodiment, the nanoscale filler is present in component (D).

The form of the reactivity enables the adhesive composition with barrier properties according to the invention to be brought in a processable state (generally liquid to highly viscous) in the required manner to the required place and to be cured by the addition of at least one compound containing at least two functional groups each with at least one acidic hydrogen atom as component (C), for example water or other compounds which have an acidic hydrogen atom. Accordingly, component (C) is also referred to as a hardener in the present specification.

In these so-called two-component systems, the hardener is generally added immediately before application, only a limited processing time being available to the user after addition of the hardener. However, the adhesive composition according to the invention containing the reactive NCO groups may also be cured solely by reaction with atmospheric moisture, i.e. without the addition of hardeners (one-component systems). One-component systems generally have the advantage over two-component systems that the user is spared the often onerous mixing of the frequently viscous components before application. However, if a certain ultimate strength is to be rapidly developed, i.e., if a high cure rate is required, for example to allow rapid further processing of the bonded materials, the cure rate based on curing by atmospheric moisture may be too slow. In cases such as these, two-component systems are preferred and component (C) is added to the adhesive as hardener before processing.

Accordingly, the present invention relates to an adhesive composition with barrier properties that, as a two-component system, contains 0 to 90% by weight and preferably 5 to 60% by weight of a compound containing at least two functional groups each with at least one acidic hydrogen atom as component (C).

The molecular weight of (C) is in the range from 50 to 10,000 g/mol, preferably in the range from 50 to 6,000 g/mol and more particularly in the range from 50 to 3,000 g/mol.

The hardener (C) is preferably a compound containing at least two functional groups each with at least one acidic hydrogen atom that are capable of reacting with the NCO groups of (A) or a mixture of two or more such compounds. Suitable functional groups with at least one acidic hydrogen atom reactive to the corresponding NCO groups of (A) are, in particular, primary or secondary amino groups, mercapto groups or OH groups. The compounds usable as the hardener (C), may contain amino groups, mercapto groups or OH groups either individually or in admixture. The functionality of the compounds usable as the hardener (C) is generally at least about two. The hardener (C) preferably contains a proportion of compounds with a higher functionality, for example with a functionality of three, four or more. The overall (average) functionality of the hardener (C) is, for example, about two (for example where only difunctional compounds are used as the hardener (C)) or more, for example about 2.1, 2.2, 2.5, 2.7 or 3. The hardener (C) may optionally have an even higher functionality, for example about four or more. The hardener (C) preferably contains a polyol bearing at least two OH groups. Corresponding polyols already described in the present specification are suitable for use as the hardener (C).

The hardener (C) is generally added in such a quantity that the ratio of functional groups reactive to the hardener (C) in the compounds (A) to groups reactive to corresponding functional groups of the compounds (A) in the hardener (C) is about 5:1 to about 1:1 and, more particularly, about 2:1 to about 1:1.

In another preferred embodiment of the invention, the adhesive composition contains at least one NCO-free compound containing at least one and preferably two or more radiation-curable, reactive functional group(s) as component (D). Compound (D) contains at least one group with an olefinically unsaturated double bond as the functional group polymerizable by exposure to UV radiation or electron beams. Acrylate or methacrylate esters with a functionality of two or more are particularly suitable as compound (D). Corresponding acrylate or methacrylate esters include, for example, esters of acrylic acid or methacrylic acid with aromatic, aliphatic or cycloaliphatic polyols or acrylates of polyether alcohols. (Meth)acrylate esters of aliphatic polyols containing 2 to about 40 carbon atoms include, for example, neopentylglycol di(meth)acrylate, 1,6-hexanediol di(meth)acrylate, trimethylol propane tri(meth)acrylate, pentaerythritol tetra(meth)acrylate, allyl (meth)acrylate, 2,3-isopropylidene glycerol (meth)acrylate, 2-acetamidoethyl (meth)acrylate, 2-benzamidoethyl (meth)acrylate, benzyl (meth)acrylate, phenylethyl (meth)acrylate, 2-phenoxyethyl (meth)acrylate, reaction product of methyl oxazoline and methacrylic acid, morpholinoethyl (meth)acrylate, glycidyl (meth)acrylate, piperidyl acrylamide, neopentyl (meth)acrylate, cyclohexyl (meth)acrylate, tert.-butyl methacrylate and tetrahydrofurfuryl (meth)acrylate, TEGDMA (tetraethylene glycol-dimethacrylate), TEDMA (triethylene glycol dimethacrylate), bisphenol-A-bis(hydroxypropyl methacrylate and (meth)acrylate esters of sorbitol and other sugar alcohols. These (meth)acrylate esters of aliphatic or cycloaliphatic diols may be modified with an aliphatic ester or an alkylene oxide. The acrylates modified with an aliphatic ester include, for example, neopentyl glycol hydroxypivalate di(meth)acrylate, caprolactone-modified neopentyl glycol hydroxypivalate di(meth)acrylates and the like. The alkylene oxide-modified acrylate compounds include, for example, ethylene oxide-modified neopentyl glycol di(meth)acrylates, propylene oxide-modified neopentyl glycol di(meth)acrylates, ethylene oxide-modified 1,6-(hexanediol di(meth)acrylates or propylene oxide-modified 1,6-hexanediol di(meth)acrylates or mixtures of two or more. thereof. (Meth)acrylate monomers based on polyether polyols include, for example, neopentyl glycol-modified (meth)acrylates, trimethylol propane di(meth)acrylates, polyethylene glycol di(meth)acrylates, polypropylene glycol di(meth)acrylates and the like. Acrylate monomers with a functionality of three or higher include, for example, trimethylol propane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]isocyanurate, caprolactone-modified tris[(meth)acryloxyethyl]isocyanurates or trimethylolpropane tetra(meth)acrylate or mixtures of two or more thereof.

Of the above-mentioned (meth)acrylate monomers with a functionality of two, three or higher which may be used as component (D) in accordance with the invention, di-, tri- and tetrapropylene glycol diacrylate, neopentyl glycol propoxylate di(meth)acrylate, trimethylolpropane tri(meth)acrylate, trimethylolpropane monoethoxy tri(meth)acrylate and pentaerythritol triacrylate are preferred.

(Meth)acrylate esters based on polyols containing urethane groups can be produced by reacting the polyols with polyisocyanates to form at least partly OH-terminated polyurethane prepolymers which are esterified with (meth)acrylic acid to form the corresponding mono- or diesters.

Particularly suitable so-called “reactive diluents” (compound (D)) are compounds (D1) that are flowable at room temperature, more particularly esters of acrylic acid or methacrylic acid. Particularly suitable compounds (D1) are, for example, the acrylic acid or methacrylic acid esters of aromatic, cycloaliphatic, aliphatic, linear or branched C₄₋₂₀ monoalcohols or of corresponding ether alcohols, for example n-butyl acrylate, 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate. The molecular weight of compound (D) is in the range from 100 to 15,000 g/mol, preferably in the range from 100 to 10,000 g/mol and more particularly in the range from 100 to 8,000 g/mol. The molecular weight of compound (D1) is in the range from 50 to 6,000 g/mol, preferably in the range from 80 to 4,000 g/mol and more particularly in the range from 100 to 2,000 g/mol.

If compound (D) is used, it makes up as much as about 80% by weight, but preferably less, for example about 40% by weight, 30% by weight or about 20% by weight, of the radiation-curable adhesive composition with barrier properties according to the invention. Smaller contents are also possible. Thus, the radiation-curable adhesive composition with barrier properties according to the invention may also contain only 10% by weight or only about 0.5 to about 8% by weight of compound (D).

The adhesive compositions with barrier properties according to the invention are highly reactive adhesives that cure in several stages. In a first stage, the adhesive is subjected by irradiation to a rapid, first curing reaction so that bonded articles or materials can be handled without difficulty. In a second curing stage, the adhesive then continues to cure until it develops the required ultimate strength. This basic procedure is described, for example, in DE 4041753 A1. Irradiation in the first stage can be carried out with UV radiation, electron beams, visible light and also IR radiation. In the case of electron beams or UV radiation, the desired product properties are adjusted through the radiation dose, in the case of IR radiation through the product temperature and the residence time. The progress of the photochemical curing reaction can be followed by IR spectroscopy (intensity and relation of the C═C and C═O bands). Irradiation with UV light or electron beams is preferred for the purposes of the invention.

If the radiation-curable adhesive composition with barrier properties according to the invention is to be polymerized in UV light, at least one photoinitiator (E) is present in the adhesive composition. A photoinitiator (E) capable of initiating the radical polymerization of olefinically unsaturated double bonds on exposure to light with a wavelength of about 215 to about 480 nm is preferably used. In principle, any commercially available photoinitiators that are compatible with the adhesive according to the invention, i.e. which form at least substantially homogeneous mixtures, may be used as the photoinitiator (E) for the purposes of the present invention. Commercially available photoinitiators such as these are, for example, any Norrish-type I fragmenting substances, for example benzophenone, camphor quinone, QUANTACURE (a product of International Bio-Synthetics), KAYACURE MBP (a product of Nippon Kayaku), ESACURE BO (a product of Fratelli Lamberti), TRIGONAL 14 (a product of Akzo), photoinitiators of the Irgacure®, Darocure® or Speedcure® series (products of Ciba Geigy), Darocure® 1173 and/or Fi-4 (made by the Eastman Company). Of these, Irgacure® 651, Irgacure® 369, Irgacure® 184, Irgacure®907, Irgacure® 1850, Irgacure®1173 (Darocure® 1173), Irgacure® 1116, Speedcure® EDB, Speedcure® ITX, Irgacure® 784 or Irgacure® 2959 or mixtures of two or more thereof are particularly suitable. Also suitable is 2,4,6-trimethylbenzene diphenyl phosphine oxide (LUCIRIN TPO, a product of BASF AG) which may also be used in admixture with one or more of the photoinitiators mentioned above.

The adhesive composition with barrier properties according to the invention contains the photoinitiator (E) in a quantity of 0 to 15% by weight, preferably 0.5 to 10% by weight and more particularly 1 to 5% by weight, based on the adhesive composition as a whole.

The adhesive composition according to the invention may optionally contain additives (F) that may make up as much as about 50% by weight of the adhesive as a whole.

The additives (F) suitable for use in accordance with the invention include, for example, plasticizers, stabilizers, antioxidants, dyes and fillers.

The plasticizers (F1) used are, for example, plasticizers based on phthalic acid, more especially dialkyl phthalates, preferred plasticizers being phthalic acid esters which have been esterified with a linear alkanol containing about 6 to about 14 carbon atoms. Diisononyl or diisotridecyl phthalate is particularly preferred. Other suitable plasticizers are benzoate plasticizers, for example sucrose benzoate, diethylene glycol dibenzoate and/or diethylene glycol benzoate, in which around 50 to around 95% of all the hydroxyl groups have been esterified, phosphate plasticizers, for example t-butyl phenyl diphenyl phosphate, polyethylene glycols and derivatives thereof, for example diphenyl ethers of poly(ethylene glycol), liquid resin derivatives, for example the methyl ester of hydrogenated resin, vegetable and animal oils, for example glycerol esters of fatty acids and polymerization products thereof.

The stabilizers or antioxidants suitable for use as additives (F2) in accordance with the present invention include phenols, sterically hindered phenols of high molecular weight (Mₙ), polyfunctional phenols, sulfur- and phosphorus-containing phenols or amines. Phenols suitable for use as additives in accordance with the invention are, for example, hydroquinone, hydroquinone methyl ether, 2,3-(di-tert.butyl)-hydroquinone, 1,3,5-trimethyl-2,4,6-tris-(3,5-di-tert.butyl-4-hydroxybenzyl)-benzene; butyl hydroxytoluene (BHT), pentaerythritol tetrakis-3-(3,5-ditert.butyl-4-hydroxyphenyl)-propionate; n-octadecyl-3,5-ditert.butyl-4-hydroxyphenyl)-propionate; 4,4-methylene-bis-(2,6-di-tert.butylphenol); 4,4-thiobis-(6-tert.butyl-o-cresol); 2,6-di-tert.butylphenol; 2,6-di-tert.butyl-n-methylphenol; 6-(4-hydroxyphenoxy)-2,4-bis-(n-octylthio)-1,3,5-triazine; di-n-octadecyl-3,5-di-tert.butyl-4-hydroxybenzyl phosphonates; 2-(n-octylthio)-ethyl-3,5-ditert.butyl-4-hydroxybenzoate; and sorbitol hexa[3-(3,5-ditert.butyl-4-hydroxyphenyl)-propionate]; and p-hydroxydiphenylamine or N,N′-diphenylenediamine or phenothiazine.

The radiation-curable adhesive with barrier properties according to the invention may contain as an additive components (F3) that improve the ageing behavior of, above all, bonds in humid atmospheres. Typical additives (F3) are, for example, ethylene/acrylamide comonomers or phosphorus derivatives. According to the invention, the phosphorus derivatives disclosed in WO 99/64529 (page 7, line 14 to page 9, line 5), for example 2-methacryloyloxyethyl phosphate, bis-2-(methacryloyloxyethyl)-phosphate or mixtures thereof, are preferably used for the purposes of the invention. Compounds containing carboxylic acids may also be used. Compounds of this type are disclosed, for example, in WO 01/16244 (page 7, line 7 to page 8, line 31) or in WO 00/29456 (page 11, line 15 to page 12, line 2). Commercially available products are obtainable, for example, from UCB Chemicals, B-1620 Drogenbos, Belgium as products of the “Ebecryl” class, for example EBECRYL 168 or EBECRYL 170.

Other additives (F4) may be incorporated in the radiation-curable adhesives with barrier properties according to the invention in order to vary certain properties. These other additives include, for example, dyes, such as titanium dioxide, fillers, such as talcum, clay and the like.

The radiation-curable adhesives with barrier properties according to the invention may optionally contain small quantities of thermoplastic, non-reactive polymers (F5), for example ethylene/vinyl acetate (EVA), ethylene/acrylic acid, ethylene/methacrylate and ethylene/n-butyl acrylate copolymers, which optionally impart additional flexibility, toughness and strength to the adhesive. Certain hydrophilic polymers (F6) may also be added, including for example polyvinyl alcohol, hydroxyethyl cellulose, hydroxypropyl cellulose, polyvinyl methyl ether, polyethylene oxide, polyvinyl pyrrolidone, polyethyl oxazolines or starch or cellulose esters, more particularly the acetates with a degree of substitution of less than 2.5. These hydrophilic polymers can increase the wettability of the adhesives according to the invention for example.

The adhesive composition with barrier properties according to the invention preferably contains

I) 5 to 98% by weight, preferably 20 to 97.5% by weight and more particularly 40 to 95% by weight of a compound containing at least one NCO group and at least one radiation-curable reactive functional group as component (A),

II) 2 to 30% by weight, preferably 2.5 to 20% by weight and more particularly 5 to 15% by weight of a nanoscale filler as component (B),

III) 0 to 90% by weight and preferably 5 to 60% by weight of a compound containing at least two functional groups with at least one acidic hydrogen atom as component (C),

IV) 0 to 80% by weight and preferably 0.5 to 40% by weight of an NCO-free compound containing at least one and preferably two or more radiation-curable reactive functional group(s) as component (D),

V) 0 to 15% by weight, preferably 0.5 to 10% by weight and more particularly 1 to 5% by weight of a photoinitiator as component (E),

VI) 0 to 50% by weight additives selected from the group consisting of plasticizers, stabilizers, antioxidants, dyes or fillers as component (F),

the sum of the components mentioned being 100% by weight.

In one particular embodiment of the invention, the adhesive composition with barrier properties contains

I) 15 to 95% by weight of component (A) as the reaction product of a low-monomer polyurethane prepolymer containing free NCO groups and at least one hydroxyacrylate from the group consisting of 2-hydroxyethyl (meth)acrylate, 2-hydroxypropyl (meth)acrylate, 3-hydroxypropyl (meth)acrylate, 6-hydroxyhexyl (meth)acrylate, the low-monomer polyurethane prepolymer being an addition product of
a) at least one polyisocyanate selected from IPDI, MDI or TDI and
b) at least one polyol with a molecular weight of 150 g/mol to 2,000 g/mol

The low-monomer polyurethane prepolymer contains less than 0.5% by weight, preferably less than 0.3% by weight and, more particularly, less than 0.1% by weight free polyisocyanate from the group consisting of IPDI, MDI or TDI, based on the total quantity of PU prepolymer.

In a particularly preferred embodiment of the invention, the adhesive composition contains 3 to 10% by weight of at least one trifunctional polyisocyanate.

The radiation-curable adhesive composition with barrier properties according to the invention may also contain up to 60% by weight of an inert solvent, depending on its intended field of application.

Basically, suitable solvents are any of the solvents known to the expert, more particularly esters, ketones, halogenated hydrocarbons, alkanes, alkenes and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, diisobutyl ketone, dioxane, ethyl acetate, ethylene glycol monobutyl ether acetate, ethylene glycol monoethyl acetate, 2-ethyl hexyl acetate, glycol diacetate, heptane, hexane, isobutyl acetate, isooctane, isopropyl acetate, methyl ethyl ketone, tetrahydrofuran or tetrachloroethylene or mixtures of two or more of the solvents mentioned.

The radiation-curable adhesive composition with barrier properties according to the invention may be produced by any of the usual techniques known to the expert for the production of polymeric mixtures.

A preferred process for the production of the adhesive composition according to the invention is characterized in that the nanoscale filler as component (B) is dispersed in component (C) and/or component (D) and the dispersion(s) obtained is/are mixed with component (A).

A particularly preferred process is characterized in that the nanoscale filler as component (B) is dispersed in component (D), component (D) being a compound (D1) that is flowable at room temperature, more particularly an ester of acrylic or methacrylic acid flowable at room temperature.

The radiation-curable adhesive compositions with barrier properties according to the invention are suitable for bonding various composite materials. Materials suitable for bonding include, for example, wood, metal, glass, plant fibers, stone, paper, cellulose hydrate, plastics, such as polystyrene, polyethylene, polypropylene, polyethylene terephthalate, polyvinyl chloride, copolymers of vinyl chloride and vinylidene chloride, copolymers of vinyl acetate olefins, polyamides, or metal foils, for example of aluminium, lead or copper.

The radiation-curable adhesive composition according to the invention is an adhesive with barrier properties that is particularly suitable for the production of film laminates. To this end, various plastic films are laminated with one another and/or with paper webs using the adhesives. The plastic films may consist of any of the plastics normally used for film production, for example polyethylene, polypropylene, more particularly stretched polypropylene produced by monoaxial or biaxial stretching (BOPP, OPP), polyesters, more particularly polyethylene terephthalate (PET), PVC, polyamide or polyimide. Both the paper webs and the plastic films may be lacquered or printed. The radiation-curable adhesive compositions with barrier properties according to the invention may be applied to the surfaces to be bonded by any suitable process, for example by spraying, knife coating, three/four roller application units where a solventless adhesive is used or two-roller application units where a solvent-containing reactive adhesive is used.

By virtue of its low viscosity, the adhesive is particularly suitable for bonding temperature-sensitive plastic films, for example polyolefin films, more particularly polyolefin films of polyethylene or polypropylene. By comparison with corresponding known films, the films according to the invention have an improved E-modulus and improved resistance to chemicals. By virtue of a minimal content of monomeric polyisocyanate, optionally after curing in a few hours, the film laminate satisfies the relevant BGVV and ECC requirements and is therefore eminently suitable for the production of flexible film laminates used in the packaging of foods.

Accordingly, the present invention also relates to a process for the production of film laminates obtainable by the part- or whole-surface bonding of at least two identical or different plastic films using the radiation-curable adhesive composition with barrier properties according to the invention. The adhesive composition may be applied to the films to be bonded using the machines typically used for such purposes, for example conventional laminating machines. It is particularly suitable to apply the adhesive composition in the liquid state to a film to be bonded to form a laminate, for example to a film of plastic, metal or paper. The viscosity of the adhesive is selected so that the adhesive has a viscosity at typical application temperatures of about 1,000 mPas to about 5,000 mPas (as measured with a Brookfield RVT DV-II digital viscosimeter, spindle 27). Typical application temperatures are, for example, about 25 to about 70° C. in the production of flexible packaging films, about 70 to about 80° C. in the lamination of high-gloss films and about 80 to about 130° C. for applications in the field of textiles. The film thus coated with the solvent-containing or solventless radiation-curable adhesive composition with barrier properties according to the invention is first thermally pre-crosslinked (condensed) in a drying tunnel at 40 to 120° C., then laminated, optionally under pressure, with at least one other film and subsequently irradiated or irradiated and then laminated.

The radiation-curable adhesive with barrier properties according to the invention increases in molecular weight as a result of the exposure to radiation and the resulting crosslinking reaction, thus possesses more cohesion and has the surface of a pressure-sensitive adhesive. If UV light is used as the radiation source, the adhesive used in accordance with the invention contains at least one photoinitiator as component (E).

The described process may be repeated several times, so that film laminates consisting of more than two bonded layers can be produced.

The process according to the invention may be carried out in an inert gas atmosphere, i.e. in the presence of inert gases, such as nitrogen. However, it may also readily be carried out with advantage in a normal atmosphere such as typically prevails in the production shops.

The present invention also relates to a laminated film produced by the process according to the invention using the adhesive composition according to the invention. The laminated film is particularly suitable as a barrier film for packaging, more particularly for the packaging of staple and luxury foods and medicaments. In the packaging of foods, barrier films are so called when their permeability to oxygen Q (O₂) is below 100 cm³/(m²×day×bar) and their permeability to water vapor Q (H₂O) is below 10 g/(m²×day) at 23°/85% relative humidity (Delventhal, Verpackungs-Rundschau 3/1991, pages 19-23). The laminated film produced by the process according to the invention has barrier properties, more particularly against CO₂, O₂, N₂, water vapor and flavors.

What is claimed is:

1. An adhesive composition with barrier properties comprising:
a) a compound containing at least one NCO group and at least one reactive functional group curable by radiation as component (A); and
b) a nanoscale filler as component (B).

2. An adhesive composition as claimed in claim 1 that additionally comprises:
c) a compound containing at least two functional groups, each with at least one acidic hydrogen atom, as component (C);
and/or
d) an NCO-free compound containing at least one reactive functional group curable by radiation as component (D).

3. An adhesive composition as claimed in claim 1, having a viscosity at 70° C. of 100 mPa·s to 26,000 mPa·s (as measured with a Brookfield RVT DV-II digital viscosimeter, spindle 27).

4. An adhesive composition as claimed in claim 1, wherein component (A) is a reaction product of at least one polyisocyanate with at least one (meth)acrylate corresponding to the following general formula:
H₂C═CR¹—C(═O)—O—R²—Y (II)
where
Y is an NCO-reactive group;
R¹ is H, CH₃; and
R² is a saturated or unsaturated, linear or branched C₂₋₂₁ alkylene group or a C₂₋₄ alkylene oxide group.

5. An adhesive composition as claimed in claim 4, wherein Y═OH, COOH, SH, NH₂, or NHR³, with R³ being a saturated or unsaturated, linear or branched C₁₋₁₈ alkyl group, C₅₋₈ cycloalkyl group, C₆₋₁₀ aryl group, or C₇₋₁₂ aralkyl group.

6. An adhesive composition as claimed in claim 4, wherein Y═OH and R2 is a C₂₋₆ alkylene group or an ethylene oxide group containing 2 to 10 ethylene oxide units or a propylene oxide group containing 1 to 7 propylene oxide units.

7. An adhesive composition as claimed in claim 4, wherein the polyisocyanate is a polyisocyanate selected from the group consisting of 1,5-naphthylene diisocyanate, 2,2′-, 2,4- and 4,4′-diphenylmethane diisocyanate (MDI), the isomers of toluene diisocyanate (TDI), 1-isocyanatomethyl-3-isocyanato-1,5,5-trimethyl cyclohexane (IPDI), hexane-1,6-diisocyanate (HDI), tetramethyl xylylene diisocyanate (TMXDI), trimerization products of the isocyanates HDI, MDI, TDI or IPDI; and NCO-terminated polyurethane prepolymers; and mixtures thereof.

8. An adhesive composition as claimed in claim 4, wherein the polyisocyanate is an NCO-terminated polyurethane prepolymer containing less than 0.5% by weight, based on the polyurethane prepolymer as a whole, of free polyisocyanate selected from the group consisting of IPDI, MDI and TDI.

9. An adhesive composition as claimed in claim 1, wherein the nanoscale filler is selected from the group consisting of oxides, nitrides, halides, sulfides, carbides, tellurides, selenides of elements of the 2^{nd} to 4^{th} main group, the transition elements and the lanthanides.

10. An adhesive composition as claimed in claim 1, wherein the nanoscale filler is selected from the group consisting of bayerite, gibbsite, diaspore, bentonite, hydrotalcite, kaolinite, mica, boehmite, vermiculite, magnesium silicate, aluminium silicate, montmorillonite, saponite, beidellite, nontronite, hectorite, stevensite, vermiculite, halloysite, the quartz modification of silicon dioxide, magnesium oxide, aluminium oxide, magnesium fluoride, cadmium sulfide, zinc sulfide, and cadmium selenide, synthetic analogs thereof and mixtures thereof.

11. An adhesive composition as claimed in claim 1, wherein the nanoscale filler has a number-weighted average particle size of 1 to 40 nm.

12. An adhesive composition as claimed in claim 1, comprising 5 to 15% by weight of the nanoscale filler as component (B).

13. An adhesive composition as claimed in claim 1 comprising:
I) 5 to 98% by weight of the compound containing at least one NCO group and at least one radiation-curable reactive functional group as component (A);
II) 2 to 30% by weight of the nanoscale filler as component (B);
III) 0 to 90% by weight of a compound containing at least two functional groups with at least one acidic hydrogen atom as component (C);
IV) 0 to 80% by weight of an NCO-free compound containing at least one radiation-curable reactive functional group as component (D);
V) 0 to 15% by weight of a photoinitiator as component (E); and
VI) 0 to 50% by weight of one or more additives selected from the group consisting of plasticizers, stabilizers, antioxidants, dyes and fillers other than said nanoscale fillers as component (F);
the sum of the components (A)-(F) being 100% by weight.

14. An adhesive composition as claimed in claim 1 comprising:
I) 20 to 97.5% by weight of the compound containing at least one NCO group and at least one radiation-curable reactive functional group as component (A);
II) 2.5 to 20% by weight of the nanoscale filler as component (B);
III) 5 to 60% by weight of a compound containing at least two functional groups with at least one acidic hydrogen atom as component (C);
IV) 0.5 to 40% by weight of an NCO-free compound containing at least two radiation-curable reactive functional groups as component (D);
V) 0.5 to 10% by weight of a photoinitiator as component (E); and
VI) 0 to 50% by weight of one or more additives selected from the group consisting of plasticizers, stabilizers, antioxidants, dyes and fillers other than said nanoscale filler as component (F);
the sum of components (A)-(F) being 100% by weight.

15. A process for producing the adhesive composition of claim 2, comprising dispersing the nanoscale filler as component (B) in component (C) and/or component (D) to obtain at least one dispersion and mixing said at least one dispersion with component (A).

16. A process as claimed in claim 15, wherein said nanoscale filler as component (B) is dispersed in component (D) and component (D) is flowable at room temperature.

17. A method for adhering a substrate using an adhesive, said method comprising using the adhesive composition of claim 1 as the adhesive.

18. A process for producing a film laminate comprised of at least two identical or different plastic films and an adhesive therebetween, said process comprising using the adhesive composition of claim 1 as the adhesive.

19. A laminated film comprised of at least two identical or different plastic films and the adhesive composition of claim 1 therebetween.

20. A laminated film as claimed in claim 19 with barrier properties, more particularly with barrier properties against CO₂, O₂, N₂, water vapor and flavors.

21. A method of packaging a food or medicament using a laminated film, said method comprising using the laminated film claimed in claim 19 as said laminated film.
